(19) United States
(12) Patent Application Publication
(10) Pub. No.: US 2017/0166803 A1
(43) Pub. Date: Jun. 15, 2017

(54) ENHANCED OIL RECOVERY

(71) Applicant: SHELL OIL COMPANY, Houston, TX (US)

(72) Inventors: Andrew PARKER, Rijswijk (NL); Gerardus GLASBERGEN, Rijswijk (NL)

(21) Appl. No.: 15/371,473

(22) Filed: Dec. 7, 2016

Related U.S. Application Data
(60) Provisional application No. 62/265,183, filed on Dec. 9, 2015.

(51) Int. Cl. C09K 8/588; E21B 43/20; E21B 43/16

(52) U.S. Cl. CPC C09K 8/588; E21B 43/16; E21B 43/20

(57) ABSTRACT

Process for enhanced oil recovery which process comprises (a) combining expandable polymer with water having a total dissolved solids content of from 1,000 to 20,000 ppm to obtain an aqueous polymer mixture, (b) injecting the aqueous polymer mixture into an oil-containing formation, and (c) recovering oil from the oil containing formation.

### CROSS REFERENCE TO RELATED APPLICATIONS

This application claims the benefit of U.S. Provisional Application No. 62/265,183, filed Dec. 9, 2015, which is incorporated herein by reference.

### FIELD OF INVENTION

The present disclosure relates to a process for enhanced oil recovery.

### BACKGROUND

In the recovery of oil from a subterranean formation, only a portion of the oil in the formation generally is recovered using primary recovery methods utilizing the natural formation pressure to produce the oil. A portion of the oil that cannot be produced from the formation using primary recovery methods may be produced by chemical enhanced oil recovery, also referred to as improved oil recovery or EOR.

One enhanced oil recovery method utilizes aqueous polymer mixtures to flood an oil-bearing formation to increase the amount of oil recovered from the formation. Aqueous dispersion of a polymer is injected into an oil-bearing formation to increase recovery of oil from the formation, either after primary recovery or after a secondary recovery water flood.

Without wishing to be bound by any theory, it is thought that the polymer increases the viscosity of the enhanced oil recovery oil recovery formulation, preferably to the same order of magnitude as the oil in the formation in order to force the mobilized oil through the formation for production by the polymer containing flood. Other beneficial effects which may take place are changes in pressure profiles due to the injection of the polymer and crossflow of oil from the low into the higher permeability parts of the reservoir.

A disadvantage of flooding a formation with polymer mixture is that the polymer containing mixtures to be injected tend to have a relatively high viscosity which makes it difficult to inject these into the formation. It has been investigated whether polymers can be made to increase in viscosity after having been injected into the formation. Such polymers are known in the art and have been described in documents such as U.S. Pat. No. 8,389,446 and U.S. Pat. No. 7,300,973. Such polymers are hereinafter referred to as expandable polymers. A secondary benefit of these expandable polymers is that they are much more resistant to mechanical shear forces. When these shear forces are applied to conventional (hydrogenated) polyacrylamide polymer, the polymer chains are scissored resulting in much lower viscosity of the polymer containing solution. These mechanical forces are especially pronounced in offshore applications where sea water often is used as the make up brine.

A disadvantage of the use of expandable polymers is that a relatively large concentration of polymer tends to be required to obtain the desired viscosity in the formation when conventional high salinity water is used for preparing the mixture.

### SUMMARY OF THE INVENTION

It now surprisingly has been found that a reduced amount of expandable polymer is required if water of reduced salinity is used in preparing expandable polymer containing mixtures having the same desired viscosity after injection into the formation. Therefore, the present invention relates to a process for enhanced oil recovery which process comprises:
(a) combining expandable polymer with water having a total dissolved solids (TDS, measured according to ASTM D5907) content of from 1,000 to 20,000 parts per million by weight (ppm) to obtain an aqueous polymer mixture,
(b) injecting the aqueous polymer mixture into an oil-containing formation, and
(c) recovering oil from the oil containing formation.

### DETAILED DISCUSSION OF THE INVENTION

The present invention relates to a process for oil production which process comprises injecting into an oil containing formation a polymer containing oil recovery formulation. Preferably, water is injected into the oil formation prior to injecting the polymer containing oil recovery formulation of the present invention. The oil can be any hydrocarbon composition present in a formation including but not limited to oil referred to as crude oil or mineral oil.

The formulation to be injected into the formation generally is prepared by first preparing a so-called mother liquor containing the various components at relatively high concentration and subsequently diluting this mother-liquor. The mother liquor can be prepared off site and later transported to the site where it is to be diluted and injected into the formation.

The use of pure water can be preferred for dissolving the polymer but pure water is not always available in sufficient quantity. Pure water is considered to be water having a total dissolved solids content (TDS, measured according to ASTM D5907) of at most 4000 ppm, more specifically at most 2000 ppm, more specifically at most 1000 ppm, most specifically at most 500 ppm. The expression “ppm” indicates parts per million by weight on total weight amount present.

In view of the shortage of pure water, an alternative preferred embodiment is to apply a combination of pure water and water having a relatively high TDS. This embodiment comprises preparing a mother liquor by adding expandable polymer to pure water and subsequently diluting the mother liquor by adding water having a substantial amount of TDS such as aqueous mixture having a TDS of at least 1,000 up to at most 80,000 ppm, more specifically of from 5,000 to 10,000 ppm.

In another preferred embodiment, mother liquor is prepared without using pure water. In this embodiment, the mother liquor is prepared by adding polymer to water preferably having a TDS of from 3,000 to 20,000 ppm. Subsequently, on site the mother liquor is diluted by adding further water having a TDS of from 3,000 to 20,000 ppm.

Water sources other than pure water are sea water, brackish water, aquifer water, formation water and brine. Water which can be used in the present process generally has a TDS of more than 1,000 ppm, more specifically at least 2,000 ppm, more specifically at least 4,000 ppm, more specifically at least 5,000 ppm. Preferably, the water has a TDS of less than 20,000 ppm, more specifically less than 15,000 ppm, more specifically is at most 10,000 ppm, most specifically at most 8,000 ppm. Most preferably, the water used for preparing the aqueous mixture has a reduced ionic strength namely of 0.15 M or less. The water preferably has an ionic strength of at most 0.1 M or at most 0.05 M, or at most 0.01 M, and may have an ionic strength of from 0.01 M to 0.15 M, or from 0.02 M to 0.125 M, or from 0.0 3M to 0.1 M. Ionic strength, as used herein, is defined by the equation

I=½*Σᵢ₌₁ ⁿ cᵢ zᵢ²

where I is the ionic strength, c is the molar concentration of ion i, z is the valency of ion i, and n is the number of ions in the measured mixture. Such water including its preparation is described in U.S. 2014/0041856.

It is especially advantageous if the water used for preparing the aqueous mixture contains a limited amount of divalent ions such as less than 4000 ppm, more specifically less than 2000 ppm, more specifically less than 1000 ppm, more specifically less than 500 ppm, more specifically less than 100 ppm, most specifically less than 20 ppm of divalent ions based on total amount of water. More specifically, these amounts relate to the calcium and/or magnesium containing salts.

Water of appropriate TDS content can be obtained by reverse osmosis of saline water using a membrane having a first surface and a second surface and (i) feeding the saline source water to the first surface of the membrane, and (ii) removing treated water of reduced salinity from the second surface of the membrane.

The expandable polymer to be added to the alkaline aqueous mixture generally is intended to provide the oil recovery formulation with a viscosity of the same order of magnitude as the viscosity of oil in the formation under formation temperature conditions so the oil recovery formulation may drive mobilized oil across the formation for production from the formation with a minimum of fingering of the oil through the oil recovery formulation and/or fingering of the oil recovery formulation through the oil. The polymer can be a single compound or can be a mixture of compounds. Preferably, the polymer is selected from the group consisting of polyacrylamide; partially hydrolyzed polyacrylamide; polyacrylate; ethylenic co-polymer; carboxymethylcelloluse; polyvinyl alcohol; polystyrene sulfonate; polyvinylpyrrolidone; biopolymers; 2-acrylamide-methyl propane sulfonate (AMPS); styrene-acrylate copolymer; co-polymers of acrylamide, acrylic acid, AMPS and n-vinylpyrrolidone in any ratio; and combinations thereof. Examples of ethylenic co-polymers include co-polymers of acrylic acid and acrylamide, acrylic acid and lauryl acrylate, and lauryl acrylate and acrylamide. Examples of biopolymers include xanthan gum, guar gum, schizophyllan and scleroglucan.

Most preferably, the polymer is polyacrylamide or hydrolyzed polyacrylamide. Preferably, expandable polymers have a particle size after expansion of at 2 least times the particle size before expansion, more specifically at least 5 times, more especially at least 10 times, more specifically at least 20 times, more specifically at least 50 times, most specifically at least 100 times. The particle size is the longest distance across the particle such as its length in case of a fiber or rod shaped particle. Especially suitable expandable polymers are expandable crosslinked polymeric microparticles as described in U.S. Pat. No. 7,300,973. More specifically, these polymers have an unexpanded volume average particle size diameter of from 0.05 to 10 microns. Expansion of the polymer is caused by differences in conditions between the environment in the formation and outside the formation before injection. The expansion generally will be triggered by an increase in temperature and/or a change in pH.

The process of the present invention is especially suitable for use offshore in which case the oil containing formation is located under a layer of water more specifically under the seabed.

The concentration of the polymer in the oil recovery formulation mother liquor may be substantially higher than the concentration of the oil recovery formulation actually injected into the formation. The concentration of polymer in this mother liquor can be of from 80 to 80,000 ppm, more specifically of from 1250 to 50000 ppm, more specifically of from 2500 to 25000 ppm, most specifically of from 5000 to 10000 ppm based on total amount of formulation.

The concentration of the polymer in the oil recovery formulation to be injected into the formation preferably is sufficient to provide the oil recovery formulation with a dynamic viscosity in the formation of at least 0.3 mPa s (0.3 cP), more specifically at least 1 mPa s (1 cP), or at least 10 mPa s (10 cP), or at least 100 mPa s (100 cP), or at least 1000 mPa s (1000 cP) at 25° C. or at a temperature within a formation temperature range. The concentration of polymer in the oil recovery formulation preferably is from 250 ppm to 10000 ppm, or from 500 ppm to 5000 ppm, or from 1000 to 2000 ppm. The polymer concentration is the average in the course of time.

Oil recovery formulation can be injected into a specific formation during a certain time frame while during the remainder of the time no polymer containing oil recovery formulation is injected such as when the formulation is injected from a vessel which moves from site to site. It is possible to inject water when no polymer containing oil recovery formulation is injected. The water to be injected can be high or low in TDS. In order to compensate for the time during which no polymer is injected, it is preferred that the concentration of the polymer in oil recovery formulation in such operation is relatively high such as of from 2000 to 30000 ppm, more preferably of from 4000 to 25000, more specifically of from 5000 to 20000 ppm based on the average polymer concentration when oil recovery formulation is injected into the formation. If the time during which no injection takes place is taken into account for calculating the average polymer concentration, the preferred average concentration of the oil recovery formulation in discontinuous injection will be similar to the average polymer concentration in continuous injection.

The molecular weight number average of the polymer in the oil recovery formulation preferably is at least 10000 daltons, or at least 50000 daltons, or at least 100000 daltons. The polymer preferably has a molecular weight number average of from 10000 to 30000000 daltons, or from 100000 to 15000000 daltons.

The oil recovery formulation may also comprise co-solvent with water, where the co-solvent may be a low molecular weight alcohol including, but not limited to, methanol, ethanol, and iso-propanol, isobutyl alcohol, secondary butyl alcohol, n-butyl alcohol, t-butyl alcohol, or a glycol including, but not limited to, ethylene glycol, 1,3-propanediol, 1,2-propandiol, diethylene glycol butyl ether, triethylene glycol butyl ether, or a sulfosuccinate including, but not limited to, sodium dihexyl sulfosuccinate. The co-solvent may be utilized for assisting in prevention of formation of a viscous emulsion. If present, the co-solvent preferably is present in an amount of from 100 ppm to 50000 ppm, or from 500 ppm to 5000 ppm of the total oil recovery formulation. A co-solvent may be absent from the oil recovery formulation.

The oil recovery formulation may additionally contain paraffin inhibitor to inhibit the formation of a viscous paraffin-containing emulsion in the mobilized oil by inhibiting the agglomeration of paraffins in the oil. The mobilized oil, therefore, may flow more freely through the formation for production relative to mobilized oil in which paraffins enhance the formation of viscous emulsions. The paraffin inhibitor of the oil recovery formulation may be a compound effective to inhibit or suppress formation of a paraffin-containing emulsion. The paraffin inhibitor may be a compound effective to inhibit or suppress agglomeration of paraffins to inhibit or suppress paraffinic wax crystal growth in the oil of the formation upon contact of the oil recovery formulation with the oil in the formation. The paraffin inhibitor may be any commercially available conventional crude oil pour point depressant or flow improver that is dispersible, and preferably soluble, in the fluid of the oil recovery formulation in the presence of the other components of the oil recovery formulation, and that is effective to inhibit or suppress formation of a paraffin-nucleated emulsion in the oil of the formation. The paraffin inhibitor may be selected from the group consisting of alkyl acrylate copolymers, alkyl methacrylate copolymers, alkyl acrylate vinylpyridine copolymers, ethylene vinylacetate copolymers, maleic anhydride ester copolymers, styrene anhydride ester copolymers, branched polyethylenes, and combinations thereof.

Commercially available paraffin inhibitors that may be used in the oil recovery formulation include HiTEC 5714, HiTEC 5788, and HiTEC 672 available from Afton Chemical Corp; FLOTRON D1330 available from Champion Technologies; and INFINEUM V300 series available from Infineum International.

The paraffin inhibitor is present in the oil recovery formulation in an amount effective to inhibit or suppress formation of a viscous paraffin-containing emulsion when the oil recovery formulation is introduced into an oil-bearing formation and contacted with oil in the formation to mobilize the oil, and the mobilized oil is produced from the formation. The paraffin inhibitor may be present in the oil recovery formulation in an amount of from 5 ppm to 5000 ppm, or from 10 ppm to 1000 ppm, or from 15 ppm to 500 ppm, or from 20 ppm to 300 ppm based on total amount of formulation. In a preferred method of the present invention, the oil recovery formulation is introduced into an oil-bearing formation or oil formation. The oil contained in the oil-bearing formation may have a dynamic viscosity under formation conditions (in particular, at temperatures within the temperature range of the formation) of at least 0.1 mPa s (0.1 cP), or at least 0.5 mPa s (0.5 cP), or at least 1 mPa s (1 cP). Most preferably, the oil contained in the oil-bearing formation may have a dynamic viscosity under formation temperature conditions of at most 10,000 mPa s (10,000 cP), more specifically at most 1,000 mPa s (1,000 cP), more specifically at most 500 mPa s (500 cP), more specifically at most 100 mPa s (100 cP), more specifically at most 50 mPa s (50 cP), more specifically at most 20 mPa s (20 cP), most specifically at most 10 mPa s (10 cP).

What is claimed is:

1. A process for enhanced oil recovery which process comprises:
(a) combining expandable polymer with water having a total dissolved solids (TDS, measured according to ASTM D5907) content of from 1,000 to 20,000 parts per million by weight (ppm) to obtain an aqueous polymer mixture,
(b) injecting the aqueous polymer mixture into an oil-containing formation, and
(c) recovering oil from the oil containing formation.

2. A process according to claim 1 in which the polymers have an unexpanded volume average particle size diameter of from 0.05 to 10 microns.

3. A process according to claim 1, wherein the expandable polymer is selected from the group consisting of polyacrylamide; partially hydrolyzed polyacrylamide; polyacrylate;
ethylenic co-polymer; carboxymethylcelloluse; polyvinyl alcohol; polystyrene sulfonate;
polyvinylpyrrolidone; biopolymers; 2-acrylamide-methyl propane sulfonate (AMPS);
styrene-acrylate copolymer; co-polymers of acrylamide, acrylic acid, AMPS and n-vinylpyrrolidone in any ratio; and combinations thereof.

4. A process according to claim 3, in which the expandable polymer is polyacrylamide.

5. A process according to claim 3, in which the expandable polymer is partially hydrolyzed polyacrylamide.

6. A process according to claim 1, in which the water has a TDS of at most 10,000 ppm.

7. A process according to claim 6, in which the water has a TDS of at most 8,000 ppm.

8. The process of claim 1, in which the oil in the underground formation prior to aqueous polymer mixture being injected has a viscosity from 0.1 cp to 5,000 cp.

9. The process of claim 1, in which the oil in the underground formation prior to aqueous polymer mixture being injected has a viscosity from 0.5 cp to 500 cp.
